(19) United States
(12) Patent Application Publication
(10) Pub. No.: US 2004/0057609 A1
(43) Pub. Date: Mar. 25, 2004

(54) Method and apparatus for cross-modality comparisons and correlation

(76) Inventor: Irving N. Weinberg, Bethesda, MD (US)

Correspondence Address: PATENT ADMINSTRATOR, KATTEN MUCHIN ZAVIS ROSENMAN, 525 WEST MONROE STREET, SUITE 1600, CHICAGO, IL, 60661-3693, US

(21) Appl. No.: 10/663,706

(22) Filed: Sep. 17, 2003

Related U.S. Application Data
(60) Provisional application No. 60/425,288, filed on Nov. 12, 2002.
(60) Provisional application No. 60/411,787, filed on Sep. 19, 2002.

(51) Int. Cl. G06K 9/00; G06K 9/64

(52) U.S. Cl. 382/128; 382/217

(57) ABSTRACT

A system and a method for determining a biopsy location in a body part are provided. The system includes a first device configured to obtain digital physiological image data about the body part, a second device configured to obtain anatomical image data about the body part, a monitor configured to display the anatomical image data, a signal processing module that includes an analog-to-digital converter configured to digitize the anatomical image data, a memory configured to store the digital physiological image data and the digitized anatomical image data, and a correlator coupled to the memory and configured to correlate the digital physiological image data with the digitized anatomical image data and to produce a combined image as a result of the correlation. A determination of a biopsy location is made on the basis of the combined image. The first device may include a positron emission tomography scanner machine. The second device may include one of the group consisting of a digital x-ray machine, an x-ray mammography machine, an x-ray cranial axial tomography machine, a magnetic resonance imaging machine, and an ultrasound machine. The system may also include a localization device, such as a computer mouse, that is configured to select a preferred subset of the second image data based on the digital physiological image data. The first device may be configured to use a predetermined spatial coordinate system. The correlator may include a transformer configured to transform the data into the predetermined spatial coordinate system.

### CROSS REFERENCE TO RELATED APPLICATIONS

This application claims priority under 35 U.S.C. 119(e) to U.S. Provisional Application Serial No. 60/411,787, entitled “Method and Apparatus for Cross-Modality Comparisons and Correlation”, filed Sep. 19, 2002, the contents of which are incorporated by reference herein. This application also claims priority under 35 U.S.C. 119(e) to U.S. Provisional Application Serial No. 60/425,288, entitled “Method and Apparatus for Comparing and Correlating PET and X-ray Images”, filed Nov. 12, 2002, the contents of which are incorporated by reference herein.

### BACKGROUND OF THE INVENTION

1. Field of the Invention

The present invention relates to a method and an apparatus for determining a biopsy location in a body part, and more particularly a method and an apparatus for correlating image data obtained from at least two separate devices to determine a biopsy location in a body part.

2. Description of the Related Art

Increasing the number of medical imaging studies that apply to a single feature or to several features can increase the diagnostic confidence of the physician interpreting the studies. Diagnostic confidence is increased further if the image sets are correlated; i.e., the spatial coordinate systems of the image sets are identical. For display purposes, once the spatial coordinate systems are shared, it is often helpful to display the images in a single window. In the past, such “correlative image displays” have been implemented by using gray-scale for one image set (i.e., x-ray) and a color scale for the second set. Alternatively, one image set uses hue and the other intensity. Aside from increasing diagnostic confidence, correlating images can be useful if each image set has a different intrinsic utility. For example, an imaging modality such as x-ray imaging has high spatial resolution and is therefore often better for guiding interventions, because the spatial resolution allows the user to avoid important anatomic structures of interest (e.g., major blood vessels). Another imaging modality (e.g., positron emission tomography, or “PET”) is useful for providing biochemical and/or physiological information about structures in the human body.

It is known in the literature that PET and x-ray images can be combined. For example, see I. Weinberg et al., “Combining X-Ray and Functional Mammography Images”, Radiology 1997, pp. 205-261. As another example, see I. Weinberg et al., “Implementing PET-Guided Biopsy: Integrating Functional Imaging Data with Digital X-Ray Mammography Cameras”, Proceedings of SPIE Volume 4319, Medical Imaging 2001: Visualization, Display, and Image-Guided Procedures, published May 2001.

### SUMMARY OF THE INVENTION

In one aspect, the invention provides a system for determining a biopsy location in a body part. The system includes a first device configured to obtain digital physiological image data about the body part, a second device configured to obtain second image data about the body part, a monitor configured to display the second image data, a signal processing module that includes an analog-to-digital converter configured to digitize the second image data, a memory configured to store the digital physiological image data and the digitized second image data, and a correlator coupled to the memory and configured to correlate the digital physiological image data with the digitized second image data and to produce a combined image as a result of the correlation. A determination of a biopsy location is made on the basis of the combined image, or on the basis of features derived from the two images. The first device may include a positron emission tomography scanner machine. The second device may include one of the group consisting of a digital x-ray machine, an x-ray mammography machine, an x-ray cranial axial tomography machine, a magnetic resonance imaging machine, and an ultrasound machine. The system may also include a localization device configured to select a preferred subset of the second image data based on the digital physiological image data obtained from the first device. The localization device may include a computer mouse. The first device may be configured to use a predetermined spatial coordinate system. The correlator may include a transformer configured to transform at least one of the digital physiological image data and the digitized second image data into the predetermined spatial coordinate system.

In another aspect, the invention provides a method for determining a biopsy location in a body part. The method includes the steps of obtaining physiological image data about the body part, obtaining independent second image data about the body part, correlating the second image data with the physiological image data, producing a combined set of image data based on the correlating, and determining a biopsy location based on the combined set of image data. The second image data may include anatomical image data, and the step of obtaining second image data may be performed by using one of the group consisting of a digital x-ray machine, an x-ray mammography machine, an x-ray cranial axial tomography machine, a magnetic resonance imaging machine, and an ultrasound machine. The step of obtaining physiological image data may be performed by using a positron emission tomography scanner machine. The obtained physiological image data may be in digital form, and the method may further include the step of digitizing the obtained second image data. The method may further include the step of selecting a preferred subset of the obtained second image data based on the obtained digital physiological image data. The step of selecting a preferred subset may be performed by using a computer mouse.

In yet another aspect, the invention provides an apparatus and a method for coupling a non-networked device to a computer network by capturing an output signal from the non-networked device, digitizing the captured signal, and processing the digitized signal with a computer for presentation and transmission over the computer network. The non-networked device may include a monitor that is configured to display the output signal to be captured. In an alternative embodiment, the invention provides an apparatus and a method for coupling a first device to a second device by capturing an output signal from the first device, digitizing the captured signal, and sending the digitized signal to the second device. The first device may include a monitor that is configured to display the output signal from the first device.

### BRIEF DESCRIPTION OF THE DRAWINGS

FIG. 1 is a block diagram of an apparatus for correlating image data according to a preferred embodiment of the present invention.

FIG. 2 is a flow chart that illustrates a method of correlating image data according to a preferred embodiment of the present invention.

### DETAILED DESCRIPTION OF THE INVENTION

The present invention is a method and apparatus for obtaining x-ray or image sets for correlation with a physiological imaging set. The invention allows a device used for physiological imaging (hereinafter referred to as a “first device”) to “grab” images from any of a variety of other devices (hereinafter referred to a “second device”), without substantially modifying the underlying software or hardware processes in any such second device. This feature is very important, because substantial modification of medical devices may affect the validation of such devices by medical regulations (e.g., according to the U.S. Food and Drug Administration). An example of a first device is a positron emission tomography (“PET”) scanner machine. Examples of second devices include digital x-ray machines, x-ray mammography machines, x-ray cranial axial tomography (CT) machines, magnetic resonance imaging (MRI) machines, ultrasound machines, or any other medical imaging device that provides an image to a computer monitor.

The method involves the use of “frame grabber” circuitry to capture an image from an output port of a second device, and then to present that captured image to the first device. The frame grabber circuitry includes a signal splitting module the also sends the signal containing the captured image to a monitor coupled to the second device. In the process of presenting the captured image to the first device, amplification and/or duplication of the output signal may be performed, as well as other image or signal processing functions. The frame grabber circuitry includes an analog-to-digital converter to convert the monitor output into a digital signal that can be manipulated. The captured image from the second device can be manipulated via mathematical algorithms (e.g., affine transformations) in software or via digital signal processing (e.g., firmware) so as to share a common spatial coordinate system with the images or data collected with the first device. Alternatively, the image from the first device may be similarly manipulated to share a common spatial coordinate system with the images or data collected with the second device. The manipulated data from the second device can be displayed with data from the first device to form a fused image.

An exemplary conventional method of capturing images from a second device and sending the captured images to a printer is known in the art, and is used by Codonics, Inc. to print images from many imaging devices. In one embodiment, the present invention provides the advantage of a method of capturing images from a second device in order to combine image sets from the second device with image sets obtained using a first device. The invention includes the use of pointing and/or localization devices (e.g., a mouse) which are coupled to the second device. Because the images shown on the second device include markers (e.g., cursors) as to the position of these pointing devices, the capture of images from the second device (and by reference, the capture of said cursors) represents a feedback loop by which the user can adjust the position of the pointing device with respect to features that are evident in either or both of the first device image and the second device image to select one or more spatial locations. Thus, a location for biopsy can be determined using either an image from the first device or one or more combined images from the first device and the second device. The determined biopsy location can then be shown to the user of the second device by having the user click or otherwise manipulate the mouse of the second device and showing or otherwise signaling the location of the second device's mouse cursor with respect to the image from the first device and/or one or more of the combined images.

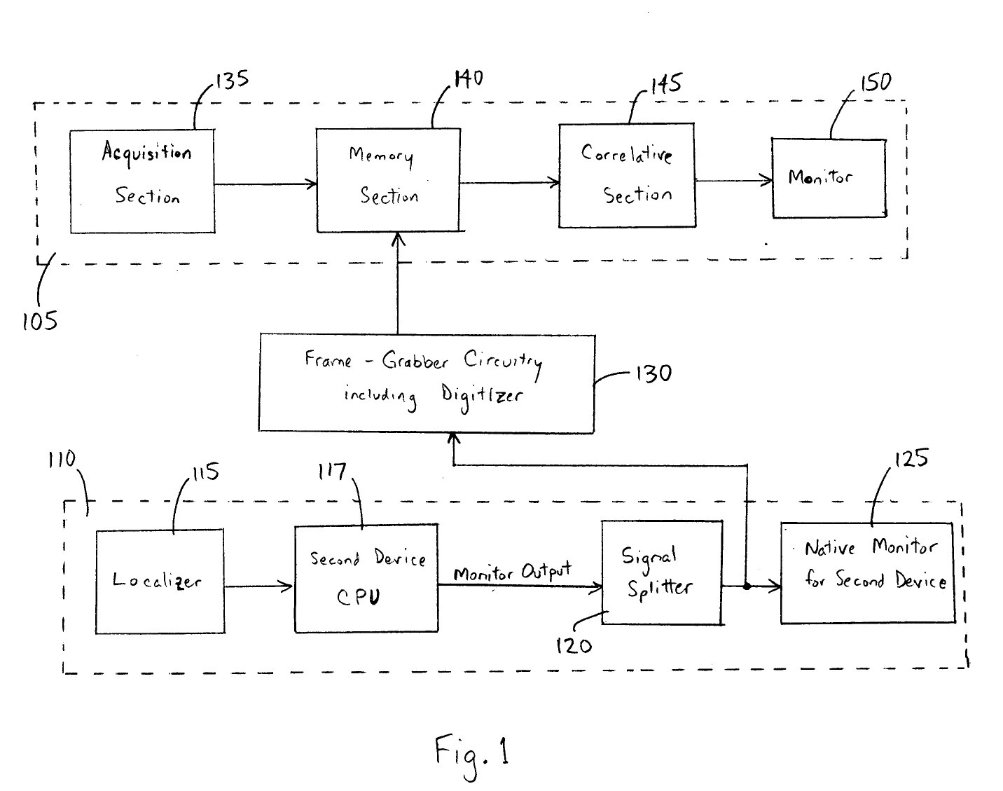

Referring to FIG. 1, a block diagram of a preferred embodiment of the invention includes a first device 105 and a second device 110. The second device 110 includes a localizer 115, such as a mouse, that can specify locations on images obtained by the second device 110 (and, with the aid of correlation, on images obtained with the first device 105); a CPU 117; a signal splitter 120; and a monitor 125. The frame-grabber circuitry 130 is coupled to both the first device 105 and the second device 110, and includes a data digitizer, such as an analog-to-digital converter (ADC). The circuitry 130 may also include a signal amplification functionality and/or other digital signal processing functionalities. The frame-grabber circuitry 130 captures the image obtained by the second device 110 as displayed on the monitor 125, digitizes the captured image, and provides the digitized image to the first device 105. The first device 105 includes an acquisition section 135 for obtaining an image (e.g., using physiological imaging as is commonly obtained with radiotracer imaging); a memory section 140 for holding the digital image data corresponding to both devices 105 and 110; and a correlative section 145 for combining the image data and indicating the determined biopsy location to the user. A monitor 150 may be used to display the combined image data to the user.

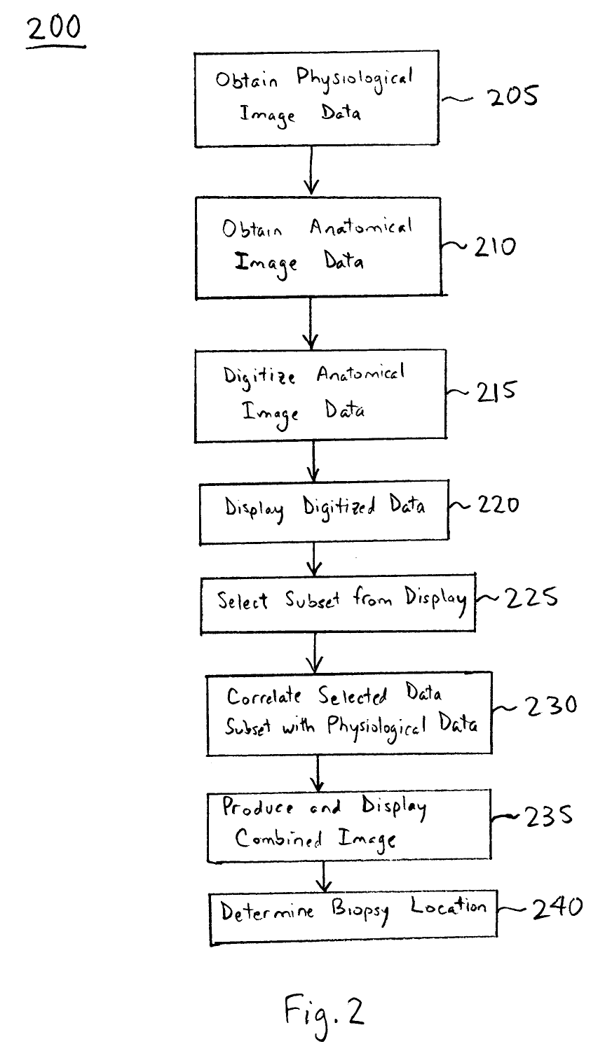

Referring to FIG. 2, a flow chart 200 illustrates a method for determining a biopsy location in a body part according to a preferred embodiment of the present invention. At the first step 205, image data about the body part is obtained using a first device. Preferably, the image data is digital and contains physiological information about the body part. The first device may be a positron emission tomography scanner machine. At the second step 210, second image data about the body part is obtained using a second device. Preferably, the second image data is anatomical image data that is transmittable to a video monitor. The second device may be one of a digital x-ray machine, an x-ray mammography machine, an x-ray cranial axial tomography machine, a magnetic resonance imaging machine, and an ultrasound machine. At the next step 215, the video signal from the second image data is captured via digitization (e.g., by an analog-to-digital converter), and at step 220, the captured digitized second image data is displayed on a monitor.

At step 225, a user selects a preferred subset of the captured digitized second image data. For example, the user may be able to use a computer mouse to select a specific area on the monitor display. Then, at step 230, the preferred subset of the captured digitized image data (said data containing anatomical or other information about the body part) is correlated with the digital image data from the first device (said data containing physiological information about the body part). At step 235, a combined set of image data is produced on the basis of the correlation. Finally, at step 240, the user determines a biopsy location based on the combined set of image data. For example, the combined set of image data may be displayed to the user on a monitor coupled to the first device, and the user may then make a visual determination of the biopsy location. The display of the combined image may also use a spatial coordinate system to enable the user to be precise in the determination of the biopsy location.

Alternatively, image data from the first and second devices may be presented in combination to the user without direct combination of the image data sets. For example, data from the second image may be processed with feature extraction software in order to generate locations of features of interest that are then superimposed on the first image data display. In one exemplary application, the location of a mouse cursor in the second image may be extracted, and the extracted location may be displayed as a cursor superimposed on the first image.

In another embodiment, a system and a method for coupling a non-networked device to a computer network are provided. The system is configured to capture an output signal from the non-networked device, digitize the captured signal, and process the digitized signal with a computer for presentation and transmission over the computer network. The non-networked device may include a monitor that is configured to display the output signal to be captured. An exemplary computer network may comprise a picture and archiving and communications system (PACS). In an alternative embodiment, a system and a method for coupling a first device to a second device are provided. The system is configured to capture an output signal from the first device, digitize the captured signal, and send the digitized signal to the second device. The first device may include a monitor that is configured to display the output signal from the first device.

While the present invention has been described with respect to what is presently considered to be the preferred embodiment, it is to be understood that the invention is not limited to the disclosed embodiments. To the contrary, the invention is intended to cover various modifications and equivalent arrangements included within the spirit and scope of the appended claims. The scope of the following claims is to be accorded the broadest interpretation so as to encompass all such modifications and equivalent structures and functions.

The contents of each of the following publications are hereby incorporated by reference:

1) 1. Weinberg et al., “Combining X-Ray and Functional Mammography Images”, Radiology 1997, pp. 205-261.

2) 1. Weinberg et al., “Implementing PET-Guided Biopsy: Integrating Functional Imaging Data with Digital X-Ray Mammography Cameras”, Proceedings of SPIE Volume 4319, Medical Imaging 2001: Visualization, Display, and Image-Guided Procedures, May 2001.

3) http://www.codonics.com/tech/saindex.htm (undated).

4) PEM-2400 User Manual, Appendix A to U.S. Provisional Patent Application No. 60/425,288, filed Nov. 12, 2002.

5) PEM-2400 Software Instructions Printout, Appendix B to U.S. Provisional Patent Application No. 60/425,288, filed Nov. 12, 2002.

What is claimed is:

1. A system for determining a biopsy location in a body part, the system comprising:
a first device configured to obtain first data about a physiology of the body part, the first data being representable as a digital image;
a second device configured to obtain second data about the body part, the second data being representable as an image;
a monitor coupled to the second device and configured to display the image corresponding to the second data;
a signal processing module coupled to the second device, the signal processing module including an analog-to-digital converter configured to digitize the second data;
a memory coupled to the signal processing module and to the first device, the memory being configured to store the first data and the digitized second data; and
a computer coupled to the memory and configured to correlate the first data with the digitized second data and to provide a result of the correlation to a user.

2. The system of claim 1, wherein the computer is further configured to use the result of the correlation to produce a combined image.

3. The system of claim 2, wherein a determination of a biopsy location is made on the basis of the combined image.

4. The system of claim 1, further comprising a localization device coupled to the second device, the localization device being configured to enable a selection of a preferred subset of the second data based on the digital image corresponding to the first data.

5. The system of claim 4, wherein the localization device comprises a computer mouse.

6. The system of claim 1, wherein the system is configured to use a predetermined spatial coordinate system, and wherein the computer includes a transformer configured to transform at least one of the first data and the digitized second data into the predetermined spatial coordinate system.

7. The system of claim 1, wherein the second device comprises one of the group consisting of a digital x-ray machine, an x-ray mammography machine, an x-ray cranial axial tomography machine, a magnetic resonance imaging machine, and an ultrasound machine.

8. The system of claim 1, wherein the first device comprises a positron emission tomography scanner machine.

9. A method for determining a biopsy location in a body part, the method comprising the steps of:
obtaining physiological image data about the body part;
obtaining second image data about the body part, the second image data being independent from the physiological image data;
correlating the second image data with the physiological image data;
producing a combined set of image data based on the correlating; and
determining a biopsy location based on the combined set of image data.

10. The method of claim 9, wherein the second image data comprises anatomical image data, and the step of obtaining second image data comprises obtaining anatomical image data using one of the group consisting of a digital x-ray machine, an x-ray mammography machine, an x-ray cranial axial tomography machine, a magnetic resonance imaging machine, and an ultrasound machine.

11. The method of claim 9, wherein the step of obtaining physiological image data comprises using a positron emission tomography scanner machine to obtain physiological image data.

12. The method of claim 9, wherein the step of obtaining physiological image data comprises obtaining digital physiological image data, and the method further comprises the step of digitizing the obtained second image data.

13. The method of claim 12, further comprising the step of selecting a preferred subset of the obtained second image data based on the obtained digital physiological image data.

14. The method of claim 13, wherein the step of selecting a preferred subset comprises using a computer mouse to select a preferred subset of the obtained second image data.

15. A method for determining a biopsy location in a body part, the method comprising the steps of:
obtaining digital physiological image data about the body part using a first device;
obtaining anatomical image data about the body part using a second device;
digitizing the anatomical image data;
displaying the digitized anatomical image data on a monitor;
selecting a preferred subset of the digitized anatomical data;
correlating the preferred subset of the digitized anatomical image data with the digital physiological image data;
producing a combined set of image data based on the correlating; and
determining a biopsy location based on the combined set of image data.

16. The method of claim 15, wherein the second device comprises one of the group consisting of a digital x-ray machine, an x-ray mammography machine, an x-ray cranial axial tomography machine, a magnetic resonance imaging machine, and an ultrasound machine.

17. The method of claim 15, wherein the first device comprises a positron emission tomography scanner machine.

18. An apparatus for determining a biopsy location in a body part, the apparatus comprising:
a physiological imaging means for obtaining first data about a physiology of the body part, the first data being representable as a digital image;
a second imaging means for obtaining second data about the body part, the second data being representable as an image;
a monitoring means for displaying the image corresponding to the second data, the monitoring means being coupled to the second imaging means;
a digitizing means for digitizing the second data, the digitizing means being coupled to the second imaging means;
a memory means for storing the first data and the digitized second data, the memory means being coupled to the digitizing means and to the physiological imaging means; and
a correlating means for correlating the first data with the digitized second data and for producing a combined image data set as a result of the correlating, the correlating means being coupled to the memory,
wherein a determination of a biopsy location is made on the basis of the combined image data set.

19. The apparatus of claim 18, further comprising a localizing means for selecting a preferred subset of the digitized second data based on the digital image corresponding to the first data, the localizing means being coupled to the second imaging means.

20. The apparatus of claim 18, wherein the apparatus is configured to use a predetermined spatial coordinate system, and wherein the correlating means includes a transforming means for transforming at least one of the first data and the digitized second data into the predetermined spatial coordinate system.

21. A system for determining a biopsy location in a body part, the system comprising:
a first device configured to obtain first data about the body part, the first data being representable as a digital image;
a second device configured to obtain second data about the body part, the second data being representable as an image;
a signal processing module coupled to the second device and configured to digitize the second data;
a memory coupled to the signal processing module and to the first device, the memory being configured to store the first data and the digitized second data; and
a computer coupled to the memory and configured to extract information from the digitized second data and display the extracted information in combination with a display of the digital image corresponding to the first data.

22. The system of claim 21, wherein the computer is further configured to superimpose the extracted information from the digitized second data onto the digital image corresponding to the first data to produce a combined image.

23. The system of claim 22, wherein a determination of a biopsy location is made on the basis of the combined image.

24. The system of claim 21, wherein the first data obtained by the first device includes data about a physiology of the body part.

25. The system of claim 21, wherein the second data obtained by the second device includes anatomical data about the body part.

26. The system of claim 21, further comprising:
a monitor coupled to the second device and configured to display the image corresponding to the second data; and
a localization device coupled to the second device and configured to enable selection of a preferred subset of the second data based on the digital image corresponding to the first data.

27. The system of claim 26, wherein the localization device comprises a computer mouse.

28. The system of claim 21, wherein the system is configured to use a predetermined spatial coordinate system, and wherein the computer includes a transformer configured to transform at least one of the first data and the digitized second data into the predetermined spatial coordinate system.

29. The system of claim 21, wherein the second device comprises one of the group consisting of a digital x-ray machine, an x-ray mammography machine, an x-ray cranial axial tomography machine, a magnetic resonance imaging machine, and an ultrasound machine.

30. The system of claim 21, wherein the first device comprises a positron emission tomography scanner machine.

31. A method of coupling a non-networked device to a computer network, the method comprising the steps of:
capturing a signal generated by the non-networked device;
digitizing the captured signal; and
conveying the digitized signal to a computer that resides on the computer network.

32. The method of claim 31, wherein the generated signal comprises an image displayable on a monitor.

33. The method of claim 31, wherein the computer network comprises a picture and archiving and communications system.
